(19) United States
(12) Patent Application Publication
(10) Pub. No.: US 2010/0051172 A1
(43) Pub. Date: Mar. 4, 2010

(54) METHOD FOR MANUFACTURING CERAMIC GREEN SHEET AND METHOD FOR MANUFACTURING MULTILAYER CERAMIC CIRCUIT BOARD

(75) Inventors: Yong Suk Kim, Yongin (KR); Yong Soo Oh, Seongnam (KR); Byeung Gyu Chang, Suwon (KR); Yong Seok Choi, Suwon (KR); Hwan Soo Lee, Seoul (KR); Sang Moon Lee, Seoul (KR); Taek Jung Lee, Hwaseong (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/410,013

(22) Filed: Mar. 24, 2009

(30) Foreign Application Priority Data
Aug. 29, 2008 (KR) 10-2008-0085469

(51) Int. Cl. B32B 37/02; B29C 59/00

(52) U.S. Cl. 156/89.12; 264/293

(57) ABSTRACT

A method for manufacturing a ceramic green sheet includes providing a stamp having an imprinting surface on which a raised structure corresponding to a circuit pattern is formed, imprinting the stamp on the ceramic green sheet to form a depressed pattern in the ceramic green sheet, the depressed pattern being transferred from the raised structure, curing the ceramic green sheet with the stamp imprinted on the ceramic green sheet, separating the stamp from the ceramic green sheet, and providing the depressed pattern of the ceramic green sheet with the conductive material.

### CROSS-REFERENCE TO RELATED APPLICATIONS

This application claims the priority of Korean Patent Application No. 2008-85469 filed on Aug. 29, 2008, in the Korean Intellectual Property Office, the disclosure of which is incorporated herein by reference.

### BACKGROUND OF THE INVENTION

1. Field of the Invention

The present invention relates to a method for manufacturing a ceramic green sheet, and more particularly, to a method for manufacturing a ceramic green sheet having a circuit pattern for a multilayer ceramic circuit board, and a method for manufacturing a multilayer ceramic circuit board by using the same.

2. Description of the Related Art

According to the recent tendency toward miniaturization of electronic components, small modules and substrates are being developed as the electronic components have higher precision and are made into fine patterns and thin layers. However, if a related art printed circuit board (PCB) is used for the miniaturized electronic components, the size reduction is limited, signal loss occurs in a high-frequency region, and reliability decreases.

In order to overcome the above limitations, a substrate using ceramics may be used instead of the printed circuit board. A Low-temperature co-fired ceramic (LTCC) substrate containing glass components is commonly used as the ceramic substrate.

A process of manufacturing the LTCC substrate begins with providing a plurality of ceramic green sheets by using slurry containing a ceramic composition.

A circuit pattern constituting an interlayer circuit is formed at each of the ceramic green sheets. Thereafter, the ceramic green sheets are stacked and fired to manufacture a multilayer ceramic circuit board.

The circuit pattern formed at the plurality of ceramic green sheets includes a conductive via and a circuit line.

In the related art, the circuit pattern is formed at the plurality of ceramic green sheets by the following processes: forming a via hole at a proper location in each ceramic green sheet by using laser processing or the like and filling the via hole with a metallic material to form a conductive via. Through this screen printing process, a desired circuit line is also formed.

In the related art method for forming the circuit pattern, a via hole and a conductive via are formed in each ceramic green sheet, and thus a process for forming a circuit line needs to be repeated, which increases a process time.

An interface of each ceramic green sheet varies in height because of the circuit pattern on the ceramic green sheet, in particular, the circuit line. In this case, when the plurality of ceramic green sheet are stacked, a specific portion protrudes, making it difficult to manufacture a multilayer ceramic circuit board with a uniform thickness.

### SUMMARY OF THE INVENTION

An aspect of the present invention provides a method for manufacturing a ceramic green sheet, which can simplify a process for forming a circuit pattern in a ceramic green sheet and improving performance by using an imprinting method.

An aspect of the present invention also provides a method for manufacturing a multilayer ceramic circuit board using a plurality of green sheets obtained by the method for manufacturing a ceramic green sheet.

According to an aspect of the present invention, there is provided a method for manufacturing a ceramic green sheet, the method including: providing a stamp having an imprinting surface on which a raised structure corresponding to a circuit pattern is formed; imprinting the stamp on the ceramic green sheet to form a depressed pattern in the ceramic green sheet, the depressed pattern being transferred from the raised structure; curing the ceramic green sheet with the stamp imprinted on the ceramic green sheet; separating the stamp from the ceramic green sheet; and providing the depressed pattern of the ceramic green sheet with the conductive material.

The circuit pattern may include a conductive via and a circuit line. The raised structure of the stamp may include at least one first raised portion corresponding to the conductive via and at least one second raised portion corresponding to the circuit line. The first raised portion may have a height that is the same as or greater than a thickness of the ceramic green sheet, and the second raised portion may have a smaller height than the first raised portion.

The stamp may include a release layer formed at least on the imprinting surface to ensure separation. The release layer may be a self-assembled molecular monolayer. The self-assembled molecular monolayer includes

CF₃(CF₂)₅(CH₂)₂SiCl₃.

The ceramic green sheet has a proper viscosity to ensure the transfer through imprinting. The viscosity may range from about 5000 cps to about 12000 cps. The ceramic green sheet may be obtained by casting ceramic slurry with a viscosity of about 1000 cps to about 2000 cps into a shape of a ceramic green sheet and pre-curing a structure resulting from the casting.

The curing the ceramic green sheet may include performing a heat treatment on the ceramic green sheet by gradually increasing a temperature according to a proper debinding temperature of a binder being used.

The providing the depressed pattern with the conductive material may include filling the depressed pattern with conductive paste by using a printing process. Alternatively, the providing the depressed pattern with the conductive material may include forming a plating layer on the depressed pattern by using a plating process.

According to another aspect of the present invention, there is provided a method for manufacturing a multilayer ceramic circuit board. The method begins with providing a plurality of ceramic green sheets each having a circuit pattern forming an interlayer circuit by using the above method for manufacturing a ceramic green sheet. Thereafter, the plurality of ceramic green sheets are stacked to form a ceramic laminate body having the interlayer circuit, and the ceramic laminate body is fired to manufacture a multilayer ceramic circuit board.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1E are cross-sectional views for explaining a method for manufacturing a stamp used in an exemplary embodiment of the present invention;

FIGS. 2A through 2E are cross-sectional views for explaining a method for manufacturing a ceramic green sheet using the stamp illustrated in FIG. 1E; and

FIGS. 3A and 3B are cross-sectional views for explaining a method for manufacturing a multilayer ceramic circuit board according to an exemplary embodiment of the present invention.

### DETAILED DESCRIPTION OF THE PREFERRED EMBODIMENT

Exemplary embodiments of the present invention will now be described in detail with reference to the accompanying drawings.

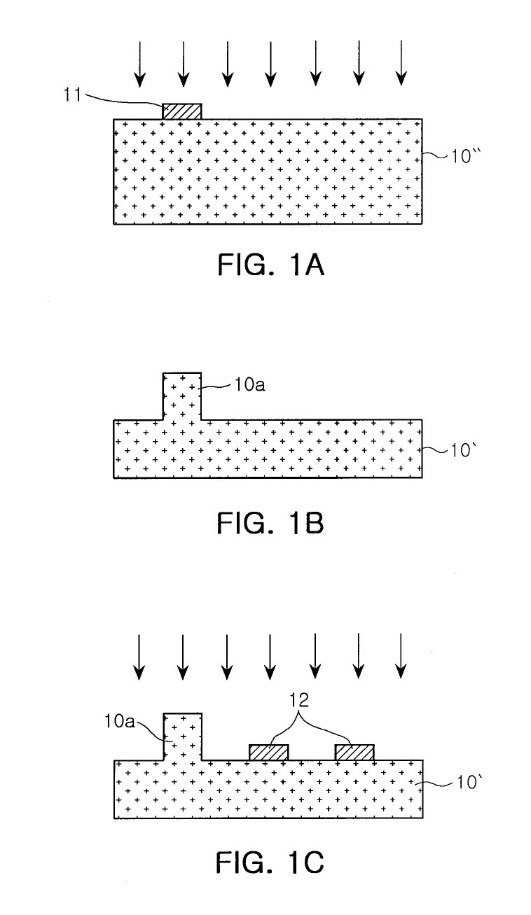

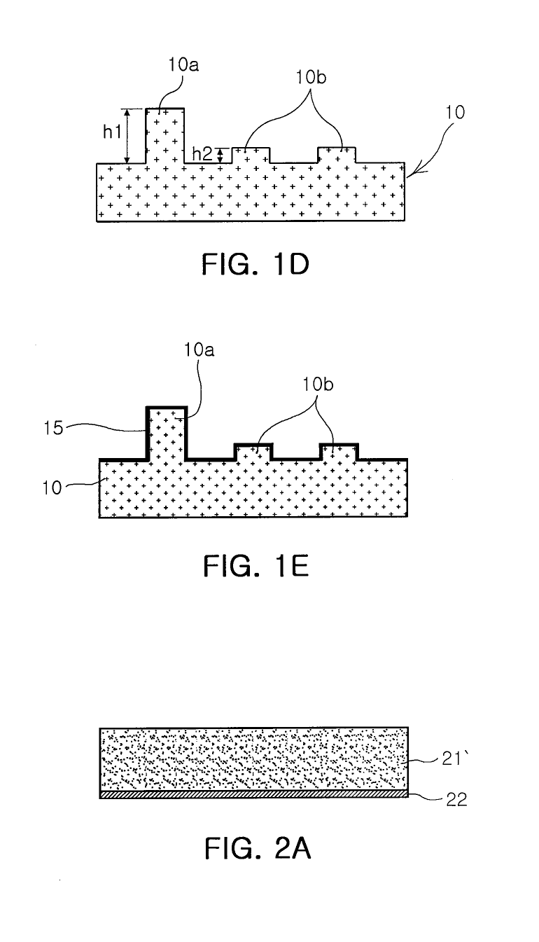

FIGS. 1A through 1D are schematic views for explaining a method for manufacturing a stamp used in an exemplary embodiment of the present invention. In this embodiment, the stamp is manufactured by using a photolithography process. The stamp manufactured using this process has a raised structure corresponding to a conductive via and a circuit line, and a photolithography process is needed for each of the conductive via and the circuit line.

As shown in FIG. 1A, the stamp manufacturing process according to the exemplary embodiment of the present invention begins with forming a first mask pattern 11 corresponding to a via formation region on a substrate 10′ which is to be used as a stamp, and performing a first etching process thereon.

A rigid material that does not change its shape while facilitating precise processing may be used as a material of the substrate 10′. Besides a glass substrate or a silicon inorganic substrate, a metal substrate may be used. However, the material of the substrate 10′ of the present invention is not limited to the above materials. The first mask pattern 11 may be a photoresist pattern obtained from the photolithography process. An etching process using the photoresist pattern is determined by the depth of a via that is to be formed.

As shown in FIG. 1B, a first raised portion 10a corresponding to a conductive via is formed on the substrate 10′ through the first etching process. The height of the first raised portion 10a is determined by the depth of etching in FIG. 1A, and is the same as or greater than a thickness of the ceramic green sheet being used.

Thereafter, as shown in FIG. 1C, a second mask pattern 12 is formed in a region corresponding to a circuit line on the substrate 10′, and then a second etching process is performed to remove the substrate 10′ to a depth corresponding to the thickness of a desired circuit line. Thus, a stamp 10 having the first raised portion 10a and a second raised portion 10b of FIG. 1D may be manufactured.

The second raised portion 10b for forming the circuit line illustrated in FIG. 1D may be obtained through the second etching process. According to the exemplary embodiment, although the first raised portion 10a is exposed by the second etching process, it can maintain its height obtained through the first etching process because a portion around the first raised portion 10a is also etched to the same depth.

The first raised portion 10a for a conductive via and the second raised portion 10b for a circuit line may have desired heights h1 and h2 through the etching processes, respectively. According to the exemplary embodiment of the present invention, if the circuit pattern which is to be formed using the stamp 10 includes a conductive via and a circuit line, the stamp 10 is designed such that the first raised portion 10a has a height h1 that is the same as or greater than a thickness of the ceramic green sheet, and the second raised portion 10b has a height h2 that is smaller than the height h1 of the first raised portion 10a.

Although not limiting the invention, in due consideration of a circuit pattern being used for a general multilayer ceramic circuit board, the first raised portion 10a may have a diameter of about 80 μm to about 120 μm and a height of about 40 μm to about 120 μm, and the second raised portion 10b may have a width of about 90 μm to about 110 μm, and a height of about 8 μm to about 12 μm.

As shown in FIG. 1E, a release layer 15 may be formed at least on an imprinting surface of the stamp 10, that is, a surface on which the raised portions 10a and 10b are placed. The release layer 15 may facilitate separation of the stamp 10 while maintaining a pattern transferred onto the ceramic green sheet.

A self-assembled molecular monolayer (SAM) may be used as the release layer 15. The release layer 15 may be formed of a material such as CH₃(CF₂)₅(CH₂)₂SiCl₃.

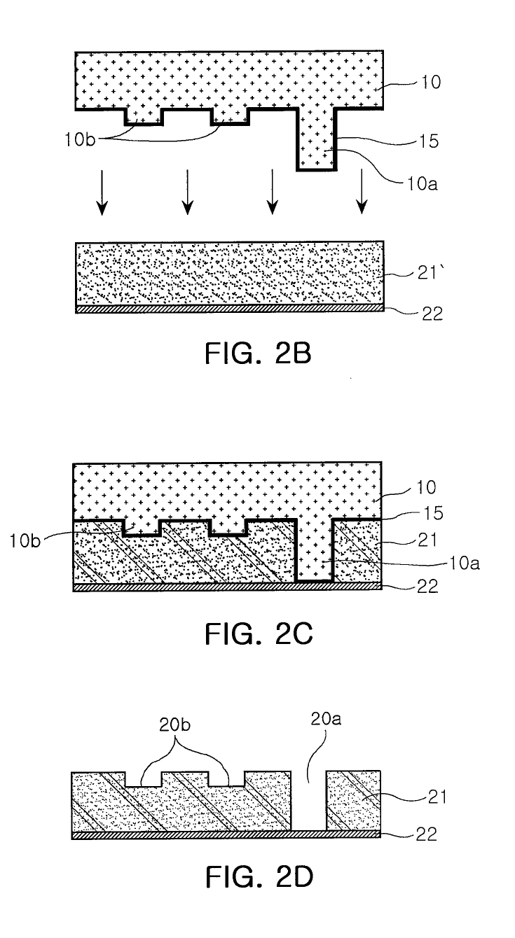

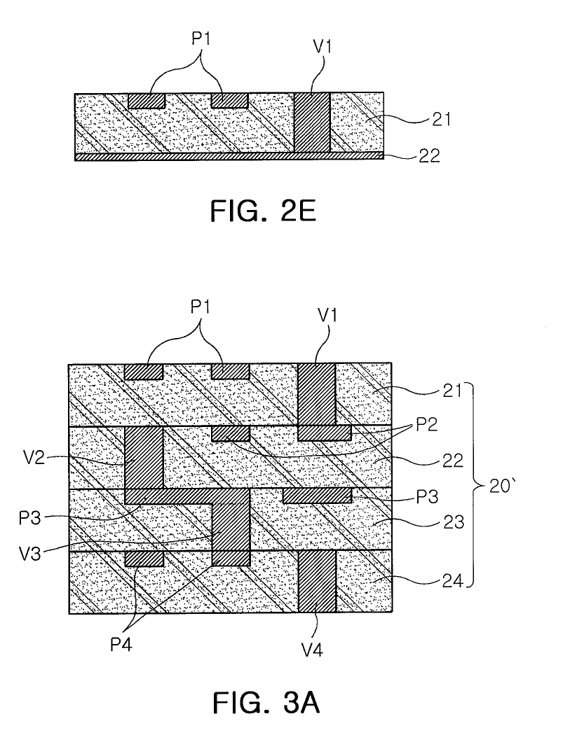

FIGS. 2A through 2E are schematic views for explaining a method for manufacturing a ceramic green sheet by using the stamp illustrated in FIGS. 1A through 1E.

As shown in FIG. 2A, a ceramic green sheet 21′ is formed on a carrier film 22.

Unlike a general ceramic green sheet, the ceramic green sheet 21′ of this embodiment is formed to have conditions facilitating an imprinting process. A desired condition for imprinting may be defined as viscosity. The ceramic green sheet 21′ may have viscosity of 8000 cps to 12000 cps, preferably about 10000 cps. The carrier film 22 may be a support film such as a polyethylene terephthalate (PET) film to facilitate handling of the ceramic green sheet 21′.

The general ceramic green sheet has almost no viscosity because it is completely dried/cured. However, the ceramic green sheet 21′ used for the present invention has a proper viscosity so that the raised structure of the stamp can be finely transferred.

The ceramic green sheet 21′ may be manufactured by using ceramic slurry that is obtained by mixing ceramic powder such as Al₂O₃, glass powder and a binder with a solvent. The ceramic slurry is in a gel phase of about 1000 cps to about 2000 cps. The ceramic slurry is made into a desired sheet shape through a known casting process such as a doctor-blade method and then undergoes pre-curing corresponding to semi-curing to provide the ceramic green sheet 21′ with a high viscosity.

Thereafter, as shown in FIG. 2B, a stamp 10 having the first and second raised portions 10a and 10b is imprinted on the ceramic green sheet 21′ with a high viscosity.

The stamp used in this stage may be understood as the stamp 10 illustrated in FIG. 11E. The stamp 10 has an imprinting surface on which the first raised portion 10a for a conductive via and the second raised portion 10b for a circuit line are formed. The stamp 10 is designed such that a height h1 of the first raised portion 10a is the same as or greater than the thickness of the ceramic green sheet, and a height h2 of the second raised portion 10b is smaller than the height h1 of the first raised portion 10a.

Thereafter, as shown in FIG. 2C, a depressed pattern corresponding to the first and second raised portions 10a and 10b is transferred onto the ceramic green sheet through the imprinting. Thereafter, the ceramic green sheet 21 is cured with the stamp 10 imprinted thereon.

As described above with reference to FIG. 2A, unlike a general sheet, the ceramic green sheet 21′ is not completely cured and thus has a high viscosity. Therefore, the depressed pattern corresponding to the first and second raised portions 10a and 10b can be easily and precisely formed. Thereafter, curing is performed with the stamp 10 mounted on the ceramic green sheet in order to maintain the depressed pattern. This curing process may be performed by gradually increasing a temperature up to a proper temperature according to a kind of a binder, thereby achieving smooth debinding and hardening. The cured ceramic green sheet 10 may be understood to be in a similar state to a generally used ceramic green sheet.

Thereafter, as shown in FIG. 2D, the stamp 10 is separated from the cured ceramic green sheet 21. As a result, the first and second raised portions 10a and 10b of the stamp 10 are transferred onto the ceramic green sheet 10 to form first and second depressed patterns 20a and 20b. The separation process may be facilitated by the release layer 15, such as an SAM, on the imprinting surface.

Next, as shown in FIG. 2E, a conductive material is provided into the first and second depressed patterns 21a and 21b of the ceramic green sheet 21. The conductive material in the first depressed pattern 21a may be provided as a conductive via V1, and the conductive material in the second depressed pattern 21b may be provided as a circuit line P1.

The providing of the conductive material into the first and second depressed patterns 21a and 21b may be a process of filling the first and second depressed patterns 21a and 21b with conductive paste by using a printing process. Of course, alternatively, a plating layer may be formed by performing a plating process to fill the first and second depressed patterns 21a and 21b with a desired material. Alternatively, the plating process and the printing process may be combined for the filling process.

As shown in FIGS. 2A through 2E, structures like a conductive via and a circuit line may be simultaneously formed through the imprinting process using the stamp 10, so that the process can be significantly simplified. Unlike complicated laser processing or punching machines, the imprinting process using the stamp can be repeated in a simple manner, remarkably increasing the manufacturing efficiency.

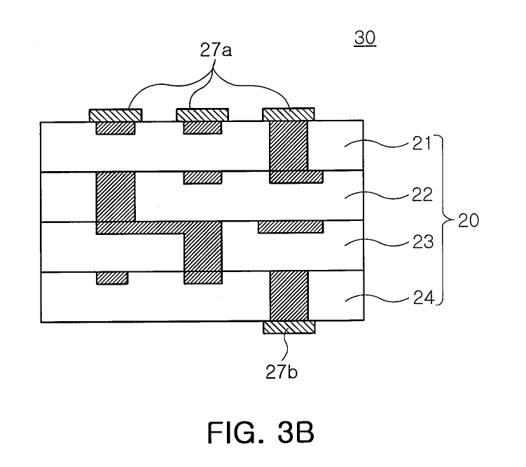

FIGS. 3A and 3B are views for explaining a method for manufacturing a ceramic substrate according to an exemplary embodiment of the present invention.

Referring to FIG. 3A, a plurality of ceramic green sheets 21, 22, 23 and 24 manufactured using the method for manufacturing a ceramic green sheet in FIGS. 2A through 2E are stacked to form a ceramic laminate body 20′. The ceramic green sheets 21, 22, 23 and 24 have respective circuit patterns P1 to P4 and V1 to V4 constituting respective interlayer circuits.

The circuit pattern formed in each of the ceramic green sheets 21, 22, 23 and 24 may be understood as being formed using a separately manufactured stamp through the process illustrated in FIGS. 1A through 1E. In this case, the circuit lines P1 to P4 are formed to be level with the respective ceramic green sheets 21, 22, 23 and 24 by filling the respective depressed patterns with a conductive material. Therefore, no height difference occurs.

As shown in FIG. 3B, the ceramic laminate body 20′ of the plurality of ceramic green sheets 21, 22, 23 and 24 may be provided as a multilayer ceramic circuit board 20 after being fired. If necessary, external electrodes 27a and 27b may be formed additionally. As described above, the circuit-pattern forming process according to the exemplary embodiment of the present invention is very simple because of the use of the imprinting process using a stamp. Also, the use of depressed patterns can prevent the height difference that would occur due to related art circuit patterns. Accordingly, the dimensional precision and reliability of a completed ceramic substrate can be expected to be improved.

According to the present invention, a circuit line, a via, a guide hole and the like, which are processed separately in the related art, can be simultaneously processed. Thus, the circuit-pattern forming process can be significantly simplified, and the high manufacturing efficiency can be expected by repeating the imprinting process using a stamp.

Since the circuit line is formed using a depressed pattern, a desired alignment of ceramic green sheets can be easily realized. Accordingly, height variations do not occur at an electrode and a ceramic structure after a firing process, so that excellent flatness can be obtained, and subsequent assembling and packaging processes can be facilitated.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for manufacturing a ceramic green sheet, the method comprising:
providing a stamp having an imprinting surface on which a raised structure corresponding to a circuit pattern is formed;
imprinting the stamp on the ceramic green sheet to form a depressed pattern in the ceramic green sheet, the depressed pattern being transferred from the raised structure;
curing the ceramic green sheet with the stamp imprinted on the ceramic green sheet;
separating the stamp from the ceramic green sheet; and
providing the depressed pattern of the ceramic green sheet with the conductive material.

2. The method of claim 1, wherein the circuit pattern includes a conductive via and a circuit line,
the raised structure of the stamp includes at least one first raised portion corresponding to the conductive via and at least one second raised portion corresponding to the circuit line, and
the first raised portion has a height that is the same as or greater than a thickness of the ceramic green sheet, and the second raised portion has a smaller height than the first raised portion.

3. The method of claim 1, wherein the stamp includes a release layer formed at least on a surface including the raised structure.

4. The method of claim 3, wherein the release layer is a self-assembled molecular monolayer.

5. The method of claim 4, wherein the self-assembled molecular monolayer includes CF₃(CF₂)₅(CH₂)₂SiCl₃.

6. The method of claim 1, wherein the ceramic green sheet has a viscosity of about 5000 cps to about 12000 cps.

7. The method of claim 6, wherein the ceramic green sheet is obtained by casting ceramic slurry with a viscosity of about 1000 cps to about 2000 cps into a shape of a ceramic green sheet, and pre-curing a structure resulting from the casting.

8. The method of claim 1, wherein the curing the ceramic green sheet comprises performing a heat treatment on the ceramic green sheet by gradually increasing a temperature.

9. The method of claim 1, wherein the providing the depressed pattern with the conductive material comprises filling the depressed pattern with conductive paste by using a printing process.

10. The method of claim 1, wherein the providing the depressed pattern with the conductive material comprises forming a plating layer on the depressed pattern by using a plating process.

11. A method for manufacturing a multilayer ceramic circuit board, the method comprising:
providing a plurality of ceramic green sheets each having a circuit pattern forming an interlayer circuit by using the method of claim 1;
stacking the plurality of ceramic green sheets to form a ceramic laminate body having the interlayer circuit; and
firing the ceramic laminate body to manufacture a multilayer ceramic circuit board.
